(19) United States
(12) Patent Application Publication
(10) Pub. No.: US 2024/0337151 A1
(43) Pub. Date: Oct. 10, 2024

(54) TENSIONING DEVICE FOR A ROLLER BLIND

(71) Applicant: ROLLEASE ACMEDA, INC., Stamford, CT (US)

(72) Inventors: Riccardo Santilli, Broadmeadows (AU); Aidan Arthur Schofield, Broadmeadows (AU); Shih Yang Chua, Broadmeadows (AU)

(21) Appl. No.: 18/591,909

(22) Filed: Feb. 29, 2024

(30) Foreign Application Priority Data
Apr. 4, 2023 (AU) 2023900976

(51) Int. Cl. E06B 9/60; E06B 9/42

(52) U.S. Cl. CPC E06B 9/60; E06B 9/42

(57) ABSTRACT

A tensioning device for a roller blind including a tube assembly about which a retractable screen is wound, the tube assembly housing an internal spring configured to be tensioned to provide for the extension and retraction of the screen, the internal spring being operably connected to a drive receiver positioned at one end of the tube assembly, the drive receiver being configured to rotate to adjust tension in the spring, the tensioning device including: a drive assembly configured to connect with and impart rotation to the drive receiver to adjust tension in the spring, a spring lock adapted to selectively prevent rotation of the tube assembly and tensioning device relative to one another, a mounting lock adapted to releasably secure the tensioning device to a wall mounting bracket, and an actuator adapted to actuate the spring lock and the mounting lock, the actuator being moveable between first and second positions.

### CROSS-REFERENCE TO RELATED APPLICATION

This application claims priority to and the benefit of the filing data of Australian Provisional Patent Application No. 2023900976, titled “Tensioning device for a roller blind” and filed on Apr. 4, 2023, the entire disclosure of which is hereby incorporated herein by reference.

### TECHNICAL FIELD

The present disclosure relates to a tensioning device for a roller blind. More particularly, the present disclosure relates to a tensioning device for tensioning a spring-loaded roller blind.

### BACKGROUND

Roller blinds may include a spring mechanism that provides a manual control option that allows the retractable screen of the roller blind to be lowered and raised by moving the base rail located at the bottom of the screen. In a ‘balanced system’, the base rail can be manually raised/lowered and remains in place at any position with the spring applying an adequate counterbalance to the mass of the screen and base rail. Depending on the width and height of the roller blind, different size springs are required to achieve a balanced system.

In addition, to achieve a balanced system, the spring is tensioned by manually applying a number of ‘pre-turns’ during the blind installation process. Adjusting tension is a tedious and time-consuming task with a special tool being required. Further, many installers use alternative tools which creates a safety issue. The tensioning process involves holding stationary the roller blind tube on which the screen is rolled and using the special tool to rotate the spring head accommodated at an end of the blind, which directly connects to the spring, to increase the tension in the spring one turn at a time.

Checking if the blind is balanced requires fully installing the roller blind so the screen can be operated. If the base rail falls to the ground this indicates that not enough pre-turns have been applied to the spring, and if the base rail rises automatically this indicates that too many pre-turns have been applied.

When the number of pre-turns needs adjusting, the roller blind tube must be completely removed, and the process is repeated. At every stage of the process, the installer must remember how many pre-turns have been applied. Once installed, there is no way of knowing how many pre-turns have been applied previously. Also, springs are designed with a maximum number of turns and if this is exceeded the life cycle of the spring is significantly reduced. Often, installers are not aware of this, and will exceed the maximum number of turns.

The process of removing and re-installing the roller blind to adjust the spring tension is also much more difficult when the blind is particularly wide, for example 5 m wide, and at considerable height with the installer having to balance on a ladder. Further, larger blinds use springs that require a lot of torque to tension and hence a significant amount of effort from the installer. If the installer slips while using the tool to apply tension, at least some of the tension will likely be released causing the tool to spin rapidly with a high amount of force and potentially cause a physical injury to the installer.

In some spring tensioning arrangements, the spring must be locked when tension is being applied. With every 360° rotation of the spring, a lock will click to indicate that the pre-tension has been held with energy stored in the spring. This pre-tension lock is then released after the roller blind tube is installed between the blind mounting brackets. The release of the stored energy in the spring allows for the operation of the blind, and enables the installer to see if the base rail and screen is balanced or not. If further adjustment to the tension is required, the spring must be again locked before the roller blind tube is removed, if not, the stored energy in the spring will let go and rapidly spin the spring head. This can be a safety issue for the installer, and may also damage the spring assembly. Even though this locking/un-locking process may sound simple, many installers either simply forget, or due to lack of training, do not know about the safety risks due to the potential energy in coil springs.

It would be desirable to provide a tensioning device for roller blind which has one or more improved features.

In this specification, unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY

In accordance with a first aspect of the present disclosure, there is provided a tensioning device for a roller blind including a tube assembly about which a retractable screen is wound, the tube assembly housing an internal spring configured to be tensioned to provide for the extension and retraction of the screen, the internal spring being operably connected to a drive receiver positioned at one end of the tube assembly, the drive receiver being configured to rotate to adjust tension in the spring, the tensioning device including: a drive assembly configured to connect with and impart rotation to the drive receiver to adjust tension in the spring, a spring lock adapted to selectively prevent rotation of the tube assembly and tensioning device relative to one another, a mounting lock adapted to releasably secure the tensioning device to a wall mounting bracket, and an actuator adapted to actuate the spring lock and the mounting lock, the actuator being moveable between a first position and a second position.

In use, when the actuator is in a first position, the tensioning device may be secured to the wall mounting bracket by the mounting lock, and the tube assembly may be released from the tensioning device to permit rotation relative to tensioning device.

In use, when the actuator is in a second position, the tensioning device may be released from the wall mounting, and the tube assembly may be secured to the tensioning device to prevent rotation relative to tensioning device.

The mounting lock may include a locking tab which is configured to abut behind a portion of the wall mounting bracket to prevent the tensioning device from axial movement, when the actuator is in the first position.

The spring lock may include a retractable tongue which projects axially from a housing portion of the tensioning device, when the actuator is in the second position.

The tube assembly may include an end section, the retractable tongue being configured to engage with the end section of the tube assembly to prevent rotation of the tube assembly, when the actuator is in the second position.

The end section of the tube assembly may include a collar member having one or more retention slots through which the retractable tongue is receivable to prevent rotation of the tube assembly, when the actuator is in the second position.

The one or more retention slots may have a length which is greater than the retractable tongue such that the tensioning device can be rotated back and forth by hand relative to the tube assembly.

The retractable tongue may include a pin and the mounting lock may include a guide track, the pin being configured to travel along the guide track when the actuator is moved between the first position and the second position.

The guide track is preferably provided in a rear side of the mounting lock and is angled such that linear movement of the locking tab provides transverse movement of the retractable tongue.

The mounting lock is preferably connected to or forms part of the actuator, the actuator being operable by a push action to move between the first and second positions.

The mounting lock may further include a front side having channel forming a circuit therein, and wherein a protruding leg of a guide block is positioned within the circuit, the protruding leg being configured to keep the mounting lock in position as the actuator moves between the first position and the second position.

The protruding leg may be positioned in an upper end of the circuit when the actuator is in the second position, and positioned behind an island formed in the circuit when the actuator is in the first position.

A housing portion of the tensioning device may include an arcuate slot through which an arcuate portion of the wall mounting bracket is receivable when mounting the tensioning device to the wall mounting bracket.

The arcuate slot preferably has a length greater than the arcuate portion of the wall mounting bracket such that the tensioning device can be rotated by hand back and forth on the wall mounting bracket.

In accordance with another aspect of the present disclosure, there is provided a tensioning device for a roller blind including a tube assembly about which a retractable screen is wound, the tube assembly housing an internal spring configured to be tensioned to provide for the extension and retraction of the screen, the internal spring being operably connected to a drive receiver positioned at one end of the tube assembly, the drive receiver being configured to rotate to adjust tension in the spring, the tensioning device including: a drive assembly configured to connect with and impart rotation to the drive receiver to thereby adjust tension in the internal spring, the drive assembly including an output drive for engaging with the drive receiver, and an input drive operatively connected to the output drive, the input drive being configured for rotation by an external source, and a revolutions counter operatively connected to the drive assembly, the revolutions counter being configured to count and indicate the number of revolutions output, thereby providing an indication of the tension applied to the internal spring.

The revolutions counter is preferably connected to the output drive and counts and indicates the number of revolutions of the output drive. The revolutions counter also preferably includes a display for providing a visual indication of the number of revolutions. The visual indication of the number of revolutions may be provided by one or more numbers.

The revolutions counter may include a primary gear, a secondary gear and an intermediate gear, the primary gear being operatively connected to a helical wheel of the output drive, the helical wheel having a single tooth which engages with the primary gear once per revolution of the output drive.

Preferably, the primary gear is operatively connected to the secondary gear via the intermediate gear, the intermediate gear being driven by the primary gear to rotate ¼ of a revolution for every revolution of the primary gear.

In one embodiment, the input drive includes a worm screw and the output drive includes a worm wheel, the worm screw being in engagement with the worm wheel, the worm wheel having a centrally located output socket configured to engage with the drive receiver, the helical wheel of the output drive being mounted to one side of the worm wheel, and the worm screw having an input socket at one end thereof for engagement by the external source.

In accordance with another aspect of the present disclosure, there is provided a tensioning device for a roller blind including a tube assembly about which a retractable screen is wound, the tube assembly housing an internal spring configured to be tensioned to provide for the extension and retraction of the screen, the internal spring being operably connected to a drive receiver positioned at one end of the tube assembly, the drive receiver being configured to rotate to adjust tension in the spring, the tensioning device including: a drive assembly configured to connect with and impart rotation to the drive receiver to thereby adjust tension in the internal spring, the drive assembly including an output drive for engaging with the drive receiver, and an input drive operatively connected to the output drive, the input drive including: a first gear configured for rotation by an external source, a gear lock adapted to releasably restrain the first gear from rotation, and a release member operable by the external source to selectively release the first gear from restrained engagement with the gear lock.

The input drive may further include a resilient member configured to bias the gear lock into abutment with the first gear, and wherein the release member is operable by the external source to push the gear lock out of said restrained engagement with the first gear.

The gear lock may include a cavity which engages with an end section of the first gear to provide said restrained engagement of the first gear. The cavity can be of generally complementary shape to that of the end section of the first gear. The cavity may include one or more upright side walls to inhibit rotation of the first gear in one direction, and one or more ramp portions configured for the first gear to ride over when the first gear is rotated in an opposite direction.

The first gear can be a worm gear having a central passageway therethrough, the passageway at one end having angled side walls providing a drive socket for engagement by an external source in the form of a tool

The release member may be a stem housed in an opposing end of the passageway, the stem being engageable by the tool when inserted into the drive socket, and wherein the gear lock is configured to be pushed away from and out of engagement with the worm gear by the stem, when the stem is pushed by the tool in the drive socket.

### BRIEF DESCRIPTION OF DRAWINGS

Various embodiments/aspects of the disclosure will now be described with reference to the following figures.

FIG. 1A is a perspective view of a tensioning device in accordance with an embodiment of the disclosure connected to a roller blind;

FIG. 1B provides a partial cross-sectional view of the tensioning device and roller blind illustrated in FIG. 1A;

FIG. 1C provides a perspective view of the tensioning device and roller blind illustrated in FIG. 1A with the tube and idler end of the roller blind and omitted;

FIG. 1D provides an exploded perspective view of the tensioning device and roller blind illustrated in FIG. 1C including the mounting bracket;

FIG. 1E is a magnified view of the tensioning device and end portion of the internal spring of the roller blind illustrated in FIG. 1D;

FIG. 1F is a perspective view of a mounting bracket, for the tensioning device shown in FIG. 1A, secured to a wall mounting end cover;

FIG. 2 is an exploded perspective view of the various internal components of the tensioning device illustrated in FIG. 1E;

FIG. 3A is a perspective view of the tensioning device shown in FIG. 1 illustrating the tongue of the spring lock in a first (retracted) position;

FIG. 3B is a perspective view of the tensioning device shown in FIG. 1 illustrating the tongue of the spring lock in a second (extended) position;

FIG. 4A is a perspective view of the tensioning device shown in FIG. 3A with one half of the tensioning device's housing removed and the tongue of the spring lock in the first (retracted) position;

FIG. 4B is a perspective view of the tensioning device shown in FIG. 3B with one half of the tensioning device's housing removed and the tongue of the spring lock in the second (extended) position;

FIG. 5A is a perspective of various internal components of the tensioning device with the mounting lock of the device secured behind a portion of the mounting bracket and the tongue of the spring lock in a retracted position relative to the end section of the tube assembly of the roller blind;

FIG. 5B provides a perspective view of various internal components of the tensioning device with the mounting lock of the device disengaged with the mounting bracket and the tongue of the spring lock engaged with the end section of the tube assembly;

FIG. 6A provides a perspective view of various internal components of the tensioning device with the mounting lock illustrated in an extended position and the tongue of the spring lock in a retracted position;

FIG. 6B provides a perspective view of various internal components of the tensioning device with the mounting block illustrated in a retracted position and the tongue of the spring lock in an extended position;

FIG. 7A is an underside view of the retractable tongue of the spring lock and the actuator when the tongue is in a retracted position;

FIG. 7B is an underside view of the retractable tongue of the spring lock and the actuator when the tongue is in an extended position;

FIG. 8A is a perspective view of the tensioning device illustrating the worm gear being restrained from rotation by the gear lock;

FIG. 8B is a perspective view of the tensioning device shown in FIG. 8A illustrating the worm gear released from the gear lock;

FIG. 9A is a perspective view of the worm gear and gear lock illustrated in FIG. 8A with the worm gear restrained from rotation by the gear lock;

FIG. 9B is a sectional view of the worm gear taken along line B-B in FIG. 9A;

FIG. 10A is a perspective view of the worm gear and gear lock illustrated in FIG. 8B with the worm gear released from the gear lock;

FIG. 10B is a sectional view of the worm gear taken along line B-B in FIG. 10A;

FIG. 11A is an underside perspective view of the gear lock and release member of the tensioning device illustrated in FIG. 1;

FIG. 11B is a bottom view of the gear lock and release member illustrated in FIG. 11A;

FIG. 12A is a side perspective view of the worm gear of the tensioning device;

FIG. 12B is a top view of the worm gear illustrated in FIG. 12A;

FIG. 12 C is an illustration of the gear lock in engagement with the top of the worm gear;

FIG. 13A is a perspective view of various internal components of the tensioning device including the gears of the revolution counter, and

FIG. 13B is an exploded perspective view of the gears of the revolution counter and the worm wheel of the drive assembly.

### DETAILED DESCRIPTION

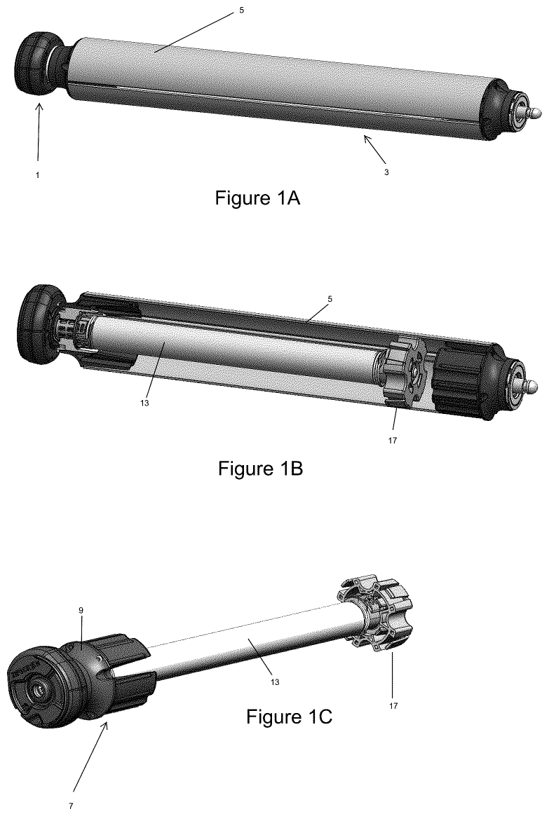

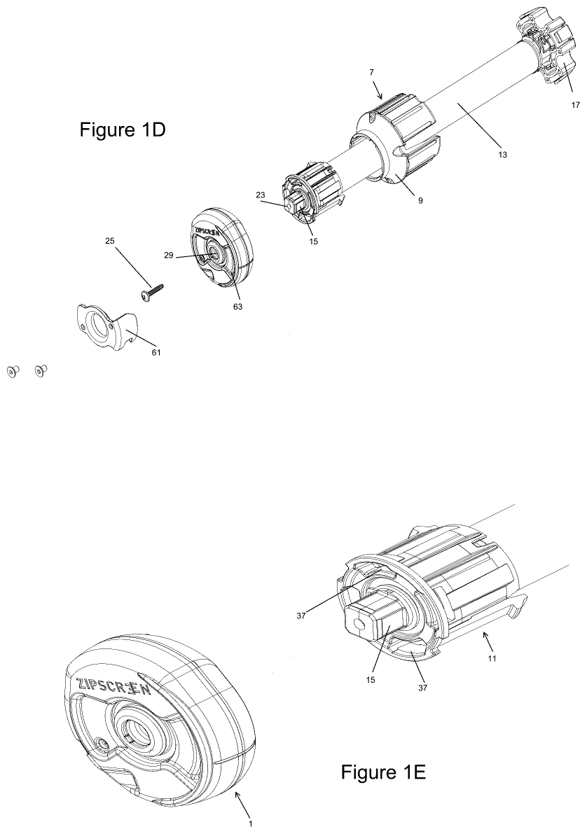

With reference to the accompanying drawings there is shown a tensioning device 1 at one end of a roller blind 3. The tensioning device 1 illustrated incorporates a range of improved features in accordance with embodiments of the disclosure. As shown in FIG. 1A-C, the roller blind 3 to which the tensioning device 1 is mounted, includes a tube assembly having a tube 5 (a hollow tube in the detailed embodiment) about which a retractable screen (not shown) is configured to be wound. The tube assembly further includes an end section 7 fixed at one end of the hollow tube 5. The end section 7 is preferably made up of at least two parts. The first part is an annular cap 9 having a portion which inserts into the end of the hollow tube 5. The second part is a collar member 11 which press-fits into a centrally located aperture in the annular cap 9. Located within the hollow tube 5 is an internal spring 13 which is configured to be tensioned to provide rotational movement to the tube 5 to extend and retract the screen provided thereon. The internal spring 13 is connected to a drive receiver, which is preferably in the form of a spigot 15, which projects from a central aperture in the collar member 11. When the tensioning device 1 is selectively operated to prevent the collar member 11 from rotating, as will be explained further below, the spigot 15 preferably receives rotational input from the tensioning device 1 which is then transferred to the internal spring 13 to adjust spring tension. When the tensioning device 1 is operated to allow the collar member 11 to rotate, along with the associated annular cap 9 and tube 5, tension in the spring 13 is transferred to rotation of the hollow tube 5 by a wheel 17 located at a free end of the spring 13. The wheel 17 is wedged with the interior walls of the tube 5, as best illustrated in FIG. 1B, to transfer motion.

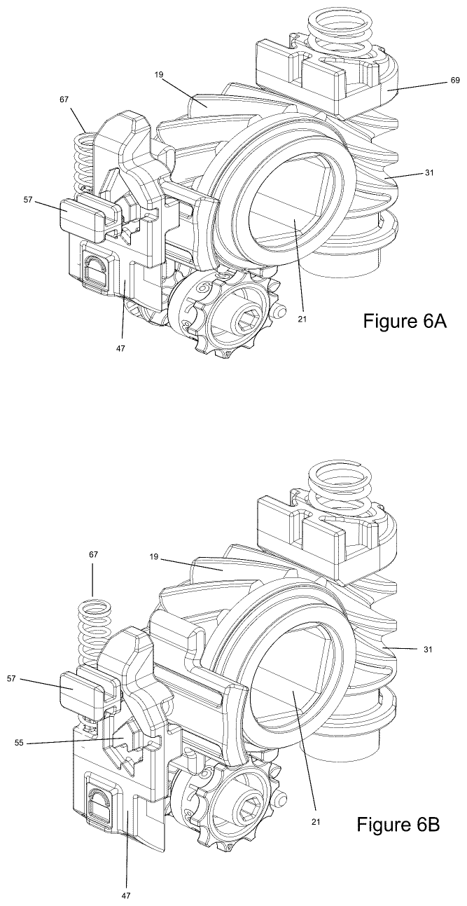

In one embodiment, the tensioning device 1 includes a drive assembly configured to connect with and impart rotation to the spigot 15 to adjust tension in the spring 13. As best illustrated in FIGS. 1D, 6A, and 8A, the drive assembly preferably includes an output drive which may be in the form of a worm wheel 19 having a centrally located output socket 21 configured to engage with the spigot 15 of the blind 3. In this respect the spigot 15 may have a threaded bore 23 to enable the worm wheel 19 to be fixed to the spigot 15 by a threaded fastener 25 which can be located through an aperture 27 located in the bottom of the output socket 21. Access to a head of the fastener 25 is provided by an overlying opening 29 in the body of the tensioning device 1. This fastener 25 also secures the tensioning device 1 to the roller blind 3.

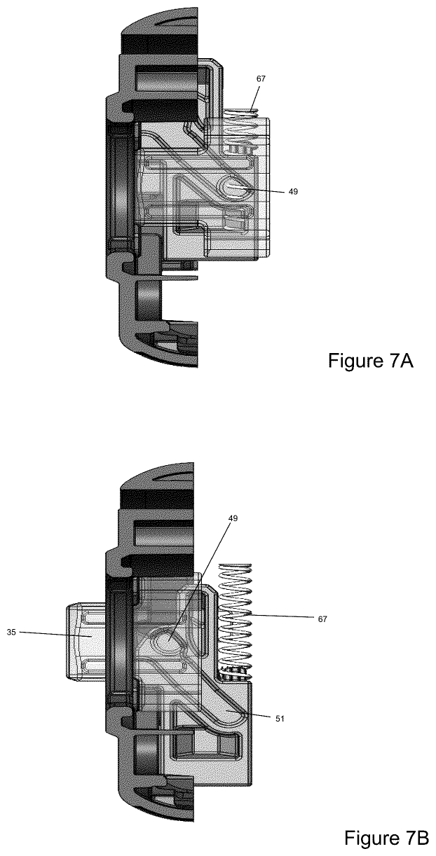

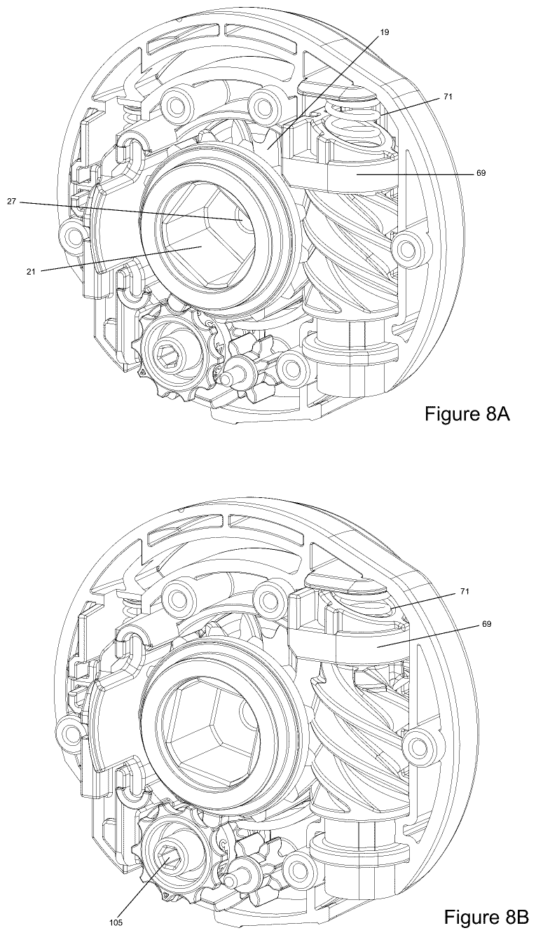

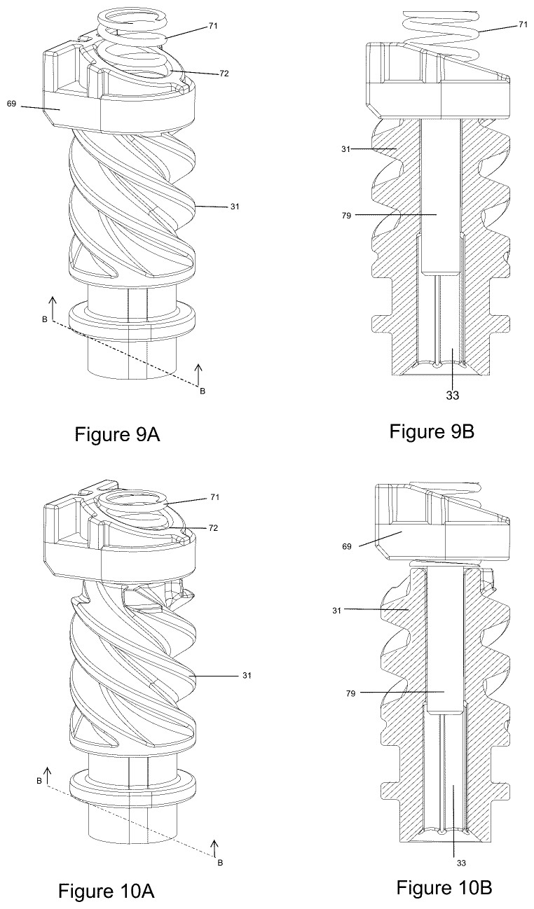

The drive assembly may also include an input drive operatively connected to the output drive. The input drive preferably includes a first gear which may be in the form of a worm gear 31 which is configured for rotation by an external source. In this regard, the worm gear 31 preferably includes a drive socket 33, for example a hex socket, at one end of the worm gear 31 for engagement by the external source which may for example be a tool such as a hand tool or power driver with an appropriate tip. The worm gear 31 and worm wheel 19 are preferably chosen to provide a gear ratio of about 3 (3 input rotations via the drive socket 33 results in one output rotation at the output socket 21). This worm gear ratio advantageously reduces the amount of effort required to apply/remove tension. The input drive may also include a gear lock 69 which functions to releasably restrain the worm gear 31 to prevent unwanted slippage of the worm gear 31 due to spring tension. The gear lock 69 is biased into engagement with an end of the worm gear 31 by a resilient member 71 having an end located in a seat 72 formed in the gear lock 69. The gear lock 69 also includes a cavity 73 of generally complementary shape to that of the worm gear end. The cavity 73 includes a plurality of upright sidewalls 75 to inhibit rotation of the worm gear 31 in one direction, and one or more ramp portions 77 which permit the worm gear 31 to ride over when rotated in an opposite direction. The input drive may also include a release member which is preferably in the form of a stem 79 which is connected to or integrally formed centrally with the gear lock 69. As illustrated in FIG. 9B, the worm gear 31 preferably includes a central passageway in which the stem 79 is located at one end with the drive socket 33 being provided at the other. The stem 79 functions to selectively release the gear lock 69 from engagement with the end of the worm gear 31. In this regard, the end of the stem 79 can be pushed by insertion of a tool such as a hand tool or power driver with the appropriate tip into the drive socket 33 to engage with the end of the stem 79. This results in the gear lock 69 being moved out of engagement with the end of the worm gear 31, as illustrated in FIG. 10B. The worm gear 31 can then be rotated both directions by the appropriate driver to adjust the tension applied to the spring 13. If the end of the stem 79 is not pushed with sufficient force to fully release the gear lock 69 from engagement with the end of the worm gear 31, the ramp portions 77 still permit rotation of the worm gear 31 in a clockwise direction to increase tension applied to the internal spring 13 of the roller blind 3. In another embodiment not illustrated, the gear lock may form part of the worm gear with serrations on the gear lock being biased into engagement with corresponding serrations provided on the housing of the tensioning device to prevent rotation of the worm gear. The gear lock being able to be pushed by insertion of a tool such as a hand tool or power driver with the appropriate tip into a drive socket in the gear lock to push the gear lock up and out of engagement with the serrations on the housing to enable rotation of the gear lock and associated worm gear.

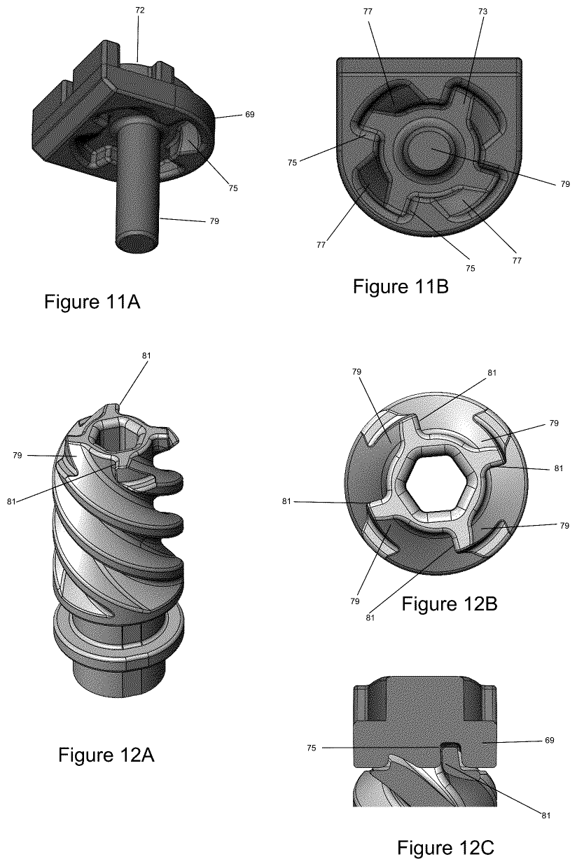

As illustrated in FIGS. 12A-12C, the end of the worm gear 31 is also provided with angled portions 79 which correspond to the ramp portions 77 of the gear lock 69. The worm gear 31 also has upright portions 81 which correspond to the upright sidewalls 75 of the gear lock 69. Abutting upright portions 81 and upright sidewalls 75 are angled slightly such that, when torque is acting on the worm gear 31, the gear lock 69 is pulled inwards towards the worm gear 81 which prevents slippage. In a further embodiment, the upright portions 81 of the gear 31 and upright sidewalls 75 of the gear lock 69 may be ramped like the one or more ramped portions 77, for example in the event that the force required to displace the resilient member 71 is particularly high.

The tensioning device 1 may further include a spring lock which may be in the form of a retractable tongue 35 which is adapted to selectively prevent rotation of the tube assembly and tensioning device 1 relative to one another. In this regard, the end section 7 of the tube 5, for example the collar member 11, preferably includes one or more retention slots 37 into which the tongue 35 may extend to prevent rotation of the tube 5.

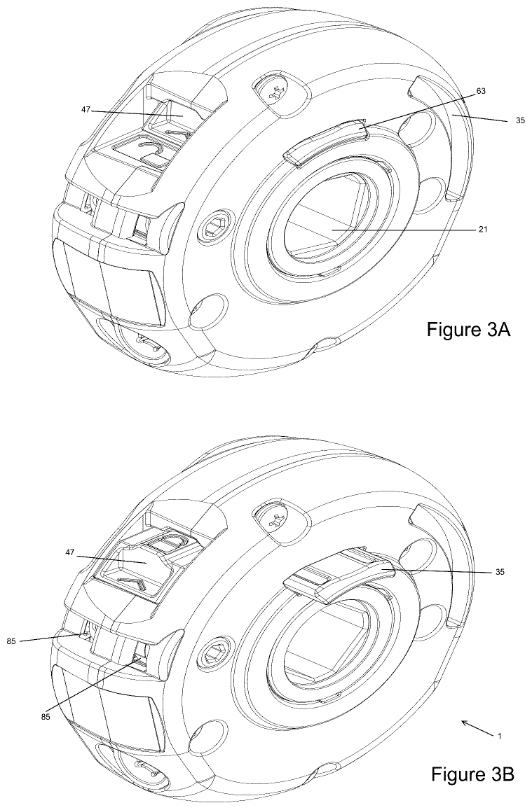

Tensioning device 1 may further include a mounting lock adapted to releasably secure the tensioning device 1 to a mounting bracket 39 which is adapted to be secured to a wall mounting end cover 41, as illustrated in FIG. 1F. A similar wall mounting end cover 41 is provided at the other end of the roller blind 3. The mounting bracket 39 includes a pin or an arm, for example an arcuate arm 61, which is receivable through a slot, for example an arcuate slot 63, provided in the housing 65 of the tensioning device 1 when securing the bracket 39 to the tensioning device 1. The mounting lock includes a locking tab 43 which is configured to abut behind a leg portion 45 of the mounting bracket 39 to prevent the tensioning device 1 moving in an axial direction, as illustrated in FIG. 5A. In this regard, the tensioning device 1 may further include an actuator 47 adapted to actuate the retractable tongue 35 and the mounting lock.

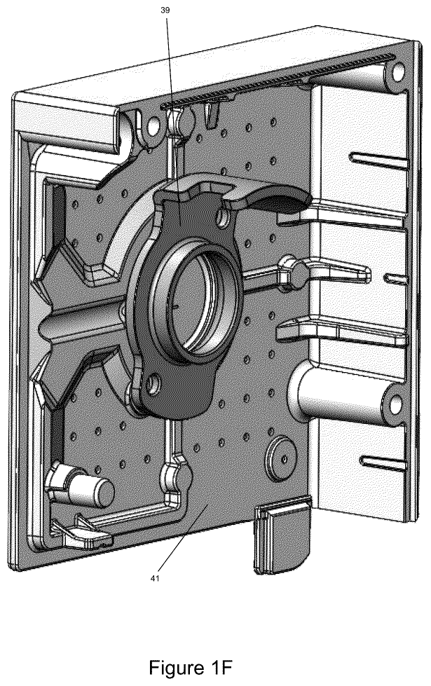

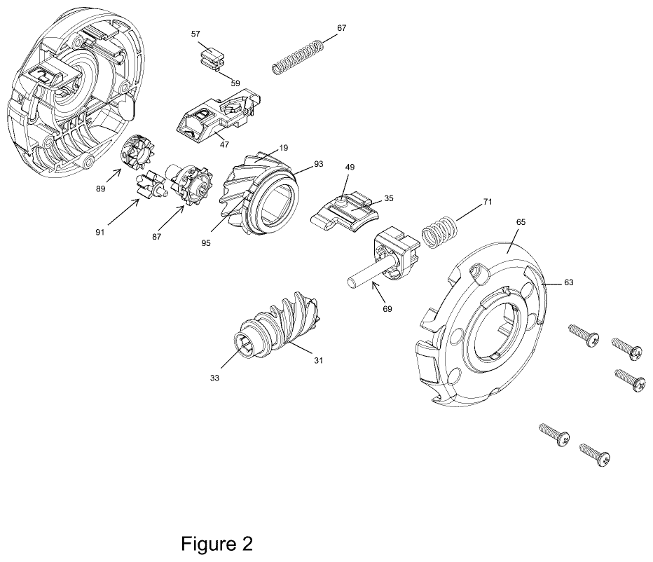

A conventional roller blind can be removed in a few different ways. For example, by swinging out one end of the blind without compressing the end pin axially, and then moving the blind axially to disengage the other end of blind. In other instances, both ends of the blind can be pulled out from the front. In some cases, the roller blind is removed by firstly moving the blind in an axial direction which compresses a resilient pin protruding at one end of the blind. Once the pin is compressed, the opposite end of the blind is free to be pulled away from the mounting bracket. However, in the present disclosure, when the actuator 47 is in a first position (unlocked position), the locking tab 43 of the mounting lock is restrained from axial movement by the mounting bracket 39. This ensures that the tensioning device 1 and roller blind 3 are not able to be removed from their mounting by axial movement. When the actuator 47 is in the first position (unlocked position), the retractable tongue 35 is in a retracted position (as illustrated in FIG. 3A) free of engagement with the collar member 11 with the roller tube 5 free to rotate relative to the tensioning device 1. During normal operation of the blind 3, the actuator 47 remains in this position. Further, in this ‘live’ state with the blind installed, tension in the spring 13 can be adjusted providing immediate visual feedback to the balancing of the blind screen and base rail.

When the actuator 47 is in a second position (locked position), the retractable tongue 35 is in an extended position (as illustrated in FIG. 3B) in which the tongue 35 projects axially from the housing of the tensioning device 1 and is engaged in one of the retention slots 37 in the collar member 11 (as illustrated in FIG. 5B). The slots 37 are preferably arcuate and have a length slightly greater than the tongue 35. This creates a gap which enables an installer to feel whether there is any tension in the blind 3. In this regard, while holding on to the tube 5 to prevent rotation, the tensioning device 1 can be slightly pivoted by hand. If spring tension is present in the blind 3, the tensioning device 1 will be able to slightly rock back and forth, with higher tension causing the tensioning device 1 to rock back with greater force. Likewise, if instead the tensioning device 1 is held to prevent rotation, the tube 5 will be able to be slightly rocked back and forth by hand.

Further, in the second position (locked position), the roller tube 5 is not able to freely rotate independently of the tensioning device 1. Accordingly, if there is any tension in the internal spring 13, the tongue 35 will advantageously be able to hold the spring tension. Further, if there is no tension in the internal spring 13, the tongue 35 will advantageously be able to prevent the weight of the blind screen and base rail causing the blind to unroll automatically. Also in the second position, the locking tab 43 is free of the mounting bracket 39 such that removal of the tensioning device 1 and roller blind 3 from their mounting safely is possible. In this regard, without the tongue 35, tension within the spring 13 would cause the tensioning device 1 to rapidly free spin when the blind 3 and tensioning device 1 is removed from the wall mounting brackets. By placing the actuator 47 in the locked position, an installer is advantageously able to install or remove the roller blind 3 without relative movement between the roller tube 5 and the tensioning device 1. Further, the installer advantageously does not need to remove tension from the spring 13 in order to safety remove the roller blind 3 and the tensioning device 1 from their mounting.

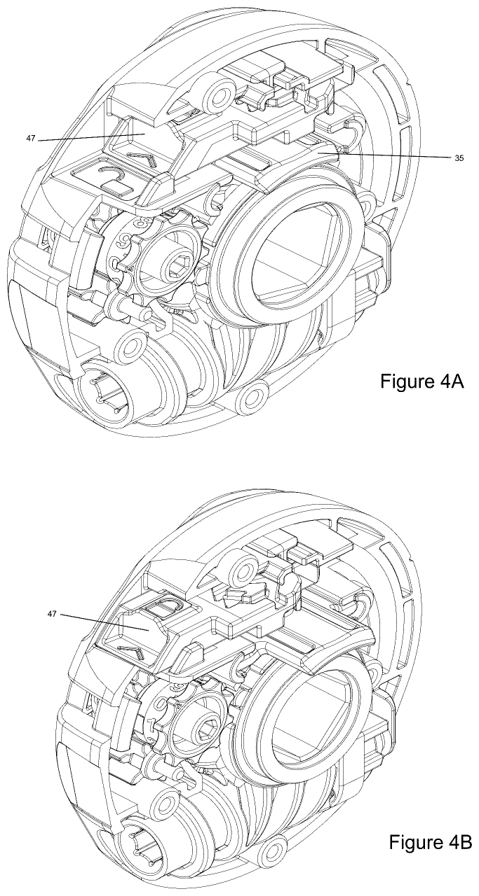

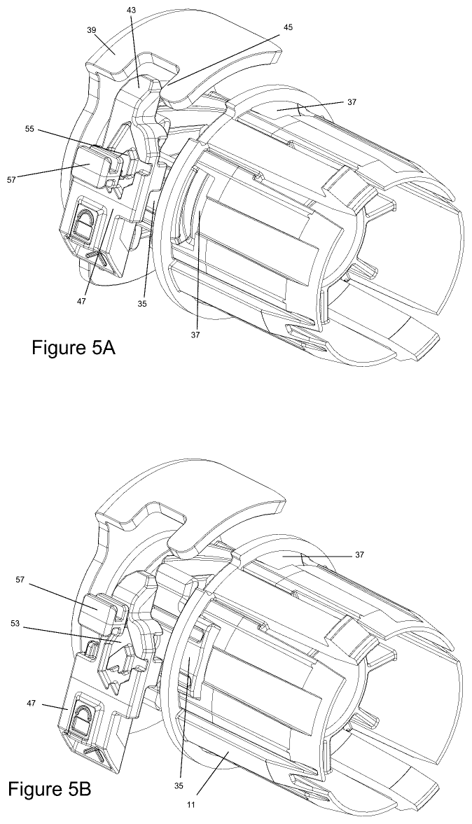

As best illustrated in FIGS. 5A and 5B, the mounting lock is preferably connected to or integrally formed as part of the actuator 47. As best shown in FIGS. 7A and 7B, an angled guide track 51 is provided in an underside of the actuator 47 and the retractable tongue 35 includes a pin 49 which travels along the guide track 51 when the actuator 47 is moved between the first and second positions. An upper face of the actuator 47 is provided with a channel 53 which forms a circuit around a centrally located island 55. A guide block 57 having a downwardly extending peg 59 is located within the channel 53 and travels around the island 55 as the actuator 47 moves back and forth between the first and second positions. More specifically, when the actuator 47 is in the first position, the peg 59 of the guide block 57 is positioned in abutment with a lower side of the island 55, as illustrated in FIGS. 5A and 6A. When the actuator 47 is in the second position, the peg 59 of the guide block 57 is positioned at an upper end of the channel, as illustrated in FIGS. 5B and 6B. A compression spring 67 between the actuator 47 and the body of the tensioner 1 is provided to maintain a downward force on the actuator 47. The actuator 47 is actuated by pushing wherein the actuator 47 stays in the depressed (unlocked) position on a first press with a second press causing the actuator 47 to pop out to the unpressed (locked) position. In an alternative embodiment, the actuator 47 can be actuated by a rotating action to toggle between the locking of the tongue 35 and tab 43. In other forms separate actuating actions for the tongue 35 and tab 43 can be provided.

The tensioning device 1 may also include a revolutions counter 83 connected to the drive assembly. In this regard, the revolutions counter 83 is preferably connected to the worm wheel 19 and is configured to count and indicate the number of revolutions output by the socket 21 to provide an indication of the tension applied to the internal spring 13 of the blind via the spigot 15 engaged in the output socket 21 of the tensioning device 1. The revolutions counter 83 preferably includes a display 85, visible through the body of the tensioning device 1, to provide a visual indication of the number of revolutions made to the spring 13. In this regard, the visual display 85 is preferably provided by one or more numbers. However, in other embodiments, the visual indication may be provided by shapes, for example a tapered triangle, rules, for example lines, or colour.

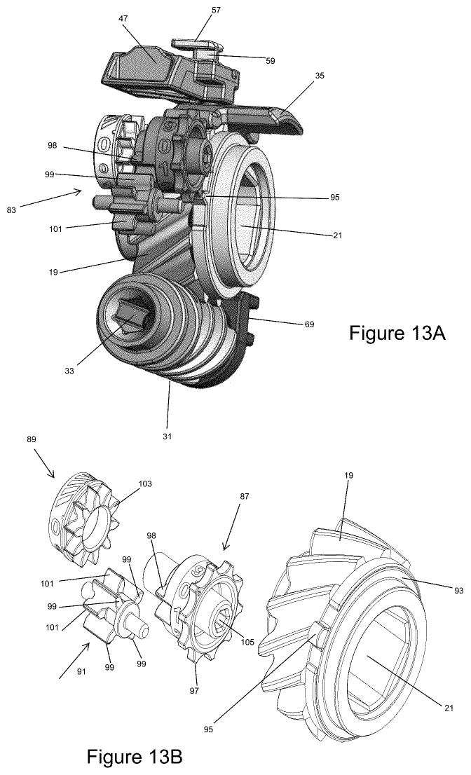

With reference to FIGS. 13A and 13B, the revolutions counter 83 preferably includes a primary gear 87, a secondary gear 89, and an intermediate gear 91. The primary gear 87 includes the numbers 0-9 printed thereon which forms part of the display 85. The primary gear 87 is operatively connected to a helical wheel 93 which is connected to or integrally formed with the worm wheel 19. The helical wheel 93 includes a single tooth 95 which engages with the primary gear 87 once per revolution of the worm wheel 19. The primary gear 87 is operatively connected to the secondary gear 89 via the intermediate gear 91. The intermediate gear 91 is driven by the primary gear 87 to rotate ¼ of a revolution for every revolution of the primary gear 87. The primary gear 87 (otherwise known as the ‘ones’ gear) is a compound gear with ten primary teeth 97 at the top and two teeth 98 at the bottom. The intermediate gear 91 includes four intermediate teeth 99 at the top for engagement with the primary gear 87. The four intermediate teeth 99 also extend to the bottom of the intermediate gear 91 to provide a total of eight intermediate teeth which includes four short intermediate teeth 101 provided at the bottom of the intermediate gear 91. The intermediate gear 91 is only rotated by the primary gear 87 when one of the four intermediate teeth 99 sits between the two teeth 98 at the bottom of the primary gear 87. This provides for the ¼ of a revolution of the intermediate gear 91 for every revolution of the primary gear 87. The intermediate gear 91 rotates the secondary gear 89 (otherwise known as the ‘tens’ gear) once every revolution of the primary gear 87. The secondary gear 89 includes ten secondary teeth 103. The eight intermediate teeth of the intermediate gear 91 are in constant mesh with the secondary gear 89 and periodically mesh with the primary gear 87. The secondary gear 89 also has the number 0-9 printed thereon which also form part of the display 85. The primary gear 87 may also include a hex socket 105 to enable the manual resetting of the counter 83 using, for example, a 3 mm allen key.

Before installing a blind 3 to a mounting bracket, installers are required to typically pre-tension the internal spring 13 by applying a number of revolutions to the spring so that the spring torque balances the torque created by the weight of the blind's screen and base rail. In some instances, the number of revolutions required during this process can reach twenty five. The revolutions counter 83 advantageously avoids installers needing to manually count the number of revolutions imparted to the internal spring 13 during the installation process of the blind 3. The displayed pre-tension count provided by the display 85 may advantageously be used to easily validate the applied pre-tension against the manufacturer's recommendation. The displayed information may also be used to assist troubleshooting during and post installation. The counter 83 also provides visual feedback if the installer has applied too many turns. Springs generally have a maximum recommended number of turns and exceeding this number will potentially damage the spring and void the warranty.

Modifications and improvements to the invention will be readily apparent to those skilled in the art. Such modifications and improvements are intended to be within the scope of this invention.

1. A tensioning device for a roller blind including a tube assembly about which a retractable screen is wound, the tube assembly housing an internal spring configured to be tensioned to provide for the extension and retraction of the screen, the internal spring being operably connected to a drive receiver positioned at one end of the tube assembly, the drive receiver being configured to rotate to adjust tension in the spring, the tensioning device comprising:
a drive assembly configured to connect with and impart rotation to the drive receiver to adjust tension in the spring,
a spring lock adapted to selectively prevent rotation of the tube assembly and tensioning device relative to one another,
a mounting lock adapted to releasably secure the tensioning device to a wall mounting bracket, and
an actuator adapted to actuate the spring lock and the mounting lock, the actuator being moveable between a first position and a second position.

2. The tensioning device of claim 1 wherein, in-use, when the actuator is in the first position, the tensioning device is secured to the wall mounting bracket by the mounting lock, and the tube assembly is released from the tensioning device to permit rotation relative to tensioning device, and wherein, when the actuator is in the second position, the tensioning device is released from the wall mounting, and the tube assembly is secured to the tensioning device to prevent rotation relative to tensioning device.

3. The tensioning device of claim 1, wherein the mounting lock includes a locking tab which is configured to abut behind a portion of the wall mounting bracket to prevent the tensioning device from axial movement, when the actuator is in the first position.

4. The tensioning device of claim 3, wherein the spring lock includes a retractable tongue which projects axially from a housing portion of the tensioning device, when the actuator is in the second position.

5. The tensioning device of claim 4, wherein the tube assembly includes an end section, the retractable tongue being configured to engage with the end section of the tube assembly to prevent rotation of the tube assembly, when the actuator is in the second position.

6. The tensioning device of claim 5, wherein the end section includes a collar member having one or more retention slots through which the retractable tongue is receivable to prevent said rotation of the tube assembly, when the actuator is in the second position.

7. The tensioning device of claim 6, wherein the one or more retention slots have a length greater than the retractable tongue such that the tensioning device can be rotated back and forth by hand relative to the tube assembly.

8. The tensioning device of claim 4, wherein the retractable tongue includes a pin and the mounting lock includes a guide track, the pin being configured to travel along the guide track when the actuator is moved between the first position and the second position.

9. The tensioning device of claim 8, wherein the guide track is provided in a rear side of the mounting lock and is angled such that linear movement of the locking tab provides transverse movement of the retractable tongue.

10. The tensioning device of claim 1, wherein the mounting lock is connected to or forms part of the actuator, the actuator being operable by a push action to move between the first and second positions.

11. The tensioning device of claim 10, wherein the mounting lock further includes a front side having channel forming a circuit therein, and wherein a protruding leg of a guide block is positioned within the circuit, the protruding leg being configured to keep the mounting lock in position as the actuator moves between the first position and the second position.

12. The tensioning device of claim 11, wherein the protruding leg is positioned in an upper end of the circuit when the actuator is in the second position, and wherein the protruding leg is positioned behind an island formed in the circuit when the actuator is in the first position.

13. The tensioning device of claim 1, wherein a housing portion of the tensioning device includes an arcuate slot through which an arcuate portion of the wall mounting bracket is receivable when mounting the tensioning device to the wall mounting bracket.

14. The tensioning device of claim 13, wherein the arcuate slot has a length greater than the arcuate portion of the wall mounting bracket such that the tensioning device can be rotated by hand back and forth on the wall mounting bracket.

15-27. (canceled)
